(19) United States
(12) Patent Application Publication
(10) Pub. No.: US 2020/0379103 A1
(43) Pub. Date: Dec. 3, 2020

(54) SYSTEM AND METHOD TO CLASSIFY OBJECTS USING RADAR DATA

(71) Applicant: NXP USA, Inc., Austin, TX (US)

(72) Inventor: Muhammad Saad Nawaz, Munich (DE)

(21) Appl. No.: 16/865,601

(22) Filed: May 4, 2020

(30) Foreign Application Priority Data
Jun. 3, 2019 (EP) 19177910.7

(51) Int. Cl. G01S 13/931; G01S 13/89; G01S 13/524; G01S 7/41

(52) U.S. Cl. CPC G01S 13/931; G01S 7/414; G01S 13/5246; G01S 13/89

(57) ABSTRACT

A system and method to classify objects using radar data obtained by an automotive radar. The system includes a convolutional network having a plurality of hidden layers comprising convolution layers for extracting features from the radar data, and an output. The system also includes a deconvolutional network having a plurality of hidden layers comprising deconvolution layers for classifying the features extracted from the radar data, and a classification output. The system also includes a filter having an input coupled to the classification output of the deconvolutional network. The system further includes a fully connected network having a plurality of fully connected layers for determining a clutter threshold value from the output of the convolutional network. The filter is operable to use the clutter threshold value to filter noise and/or clutter from the classification output of the deconvolutional network and pass a filtered classification output to an output of the system.

### FIELD OF THE INVENTION

The present specification relates to a system operable to classify objects using radar data obtained by an automotive radar. The present specification also relates to a hardware accelerator or graphics processing unit comprising the system. The present specification further relates to a vehicle comprising the hardware accelerator or the graphics processing unit. The present specification also relates to a method of classifying objects using radar data obtained by an automotive radar.

### BACKGROUND

With the advancements in automotive radars over the years, the applications have gone beyond mere detection of objects. Imaging radars are now capable of reflecting several points from targets. However, the processing capability of automotive radar sensors (in terms of classification) is lacking behind.

### SUMMARY

Aspects of the present disclosure are set out in the accompanying independent and dependent claims. Combinations of features from the dependent claims may be combined with features of the independent claims as appropriate and not merely as explicitly set out in the claims.

According to an aspect of the present disclosure, there is provided a system operable to classify objects using radar data obtained by an automotive radar, the system comprising:

a convolutional network comprising:
an input for receiving the radar data;
a plurality of hidden layers comprising convolution layers for extracting features from the radar data;
and an output;

a bus coupled to the output of the convolutional network;

a deconvolutional network comprising:
an input coupled to the bus to receive the output of the convolutional network,
a plurality of hidden layers comprising deconvolution layers for classifying the features extracted from the radar data by the convolutional network; and
a classification output;

a filter having an input coupled to the classification output of the deconvolutional network;

a fully connected network comprising:
an input coupled to the bus for receiving the output of the convolutional network;
a plurality of fully connected layers for determining a clutter threshold value from the output of the convolutional network; and
an output connected to the filter to provide the clutter threshold value to the filter; and

an output coupled to the filter,

wherein the filter is operable to use the clutter threshold value to filter noise and/or clutter from the classification output of the deconvolutional network and pass a filtered classification output to the output of the system.

According to another aspect of the present disclosure, there is provided a method of classifying objects using radar data obtained by an automotive radar, the method comprising:

a convolutional network:
receiving the radar data; and
using a plurality of hidden layers comprising convolution layers to extract features from the radar data;

a deconvolutional network:
receiving an output of the convolutional network;
using a plurality of hidden layers comprising deconvolution layers to classify the features extracted from the radar data by the convolutional network; and
providing a classification output;

a fully connected network:
receiving the output of the convolutional network; and
using a plurality of fully connected layers to determine a clutter threshold value from the output of the convolutional network; and

a filter using the clutter threshold value to filter noise and/or clutter from the classification output of the deconvolutional network to produce a filtered classification output.

The claimed system and method may improve the accuracy and consistency by which objects detected by a radar system can be classified. This may be achieved due to the provision of the filter, which filters out noise and/or clutter based on the clutter threshold value produced by the fully connected network, to produce the filtered classification output.

The system of may further comprise a skip connections bus having one or more skip connections coupleable between the convolutional network and the deconvolutional network. This can allow at least some of the convolution layers and deconvolution layers to be bypassed. This can allow the fast/efficient classification of objects to be achieved.

Each skip connection may allow high-level extracted features learned during early convolution layers of the convolutional network to be passed directly to the deconvolutional network.

The system may be operable selectively to couple/decouple a skip connection between a convolution layer and a deconvolution layer.

The filter may be operable to filter out any detected features having a value less than the clutter threshold value.

The value of each detected feature may comprise a radar cross section value.

The clutter threshold value may be a single value.

The system may comprise a controller for controlling at least one of: a stride size; a padding size; and a dropout ratio, for each layer in the convolutional and/or deconvolutional network.

The radar data may comprise at least one of range, doppler and spatial information.

The filtered classification output may classify objects detected by the automotive radar. Examples of such objects include vehicles, street furniture, building and pedestrians.

The system and method described herein may use various activation functions of the kind that are known in the art of neural networks. For instance, the activation function may be a linear activation function, a step activation function, a hyperbolic tangent activation function of a Rectified Linear (ReLu) activation function. The clutter threshold value may be calculated in accordance with the activation function.

The method may comprise selectively coupling a skip connection between the convolutional network and the deconvolutional network for bypassing at least some of the convolution layers and deconvolution layers.

According to a further aspect of the present disclosure, there is provided a hardware accelerator comprising the system of any of claims 1 to 10.

According to another aspect of the present disclosure, there is provided a graphics processing unit comprising the system of any of claims 1 to 10.

According to a further aspect of the present disclosure, there is provided a vehicle comprising the hardware accelerator of claim 11 or the graphics processing unit of claim 12.

### BRIEF DESCRIPTION OF THE DRAWINGS

Embodiments of this disclosure will be described hereinafter, by way of example only, with reference to the accompanying drawings in which like reference signs relate to like elements and in which:

FIG. 1 shows a system comprising a neural network architecture according to an embodiment of this disclosure;

FIG. 2A shows the convolutional network of the neural network architecture of FIG. 1 in more detail, according to an embodiment of this disclosure;

FIG. 2B shows the fully connected network of the neural network architecture of FIG. 1 in more detail, according to an embodiment of this disclosure;

FIG. 2C shows the deconvolutional network of the neural network architecture of FIG. 1 in more detail, according to an embodiment of this disclosure;

FIG. 2D shows the filter of the neural network architecture of FIG. 1 in more detail, according to an embodiment of this disclosure;

FIG. 3 compares the dimensions of the input and output of the neural network architecture of FIG. 1 according to an embodiment of this disclosure; and

FIG. 4 shows a ReLu activation function and clutter threshold value according to an embodiment of this disclosure.

### DETAILED DESCRIPTION

Embodiments of this disclosure are described in the following with reference to the accompanying drawings.

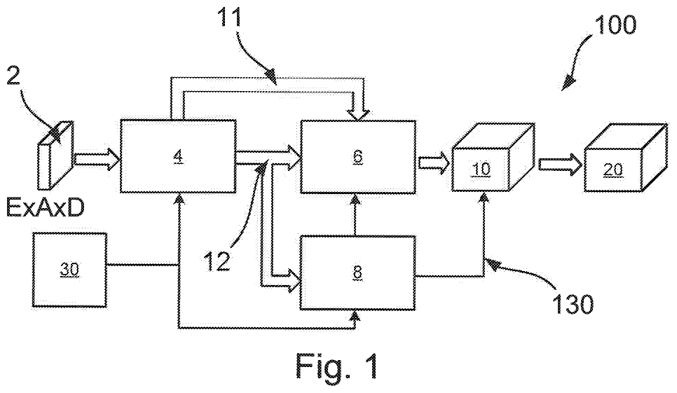

FIG. 1 shows a system 100 comprising a neural network architecture according to an embodiment of this disclosure. The system 100 is operable to classify objects using radar data. The radar data is typically radar data that has been acquired by a vehicle radar. Accordingly, examples of objects to be classified include vehicles, street furniture, building and pedestrians. The radar data may, for instance, comprise range, doppler and spatial information.

The system 100 includes a convolutional network 4. The convolutional network 4 includes an input that for receiving the radar data. The convolutional network 4 comprises a set of hidden layers. The hidden layers may include convolution layers and/or subsampling layers. The hidden layers are operable to extract features from the radar data received at the input. The convolutional network 4 further includes an output.

The radar data may be in the form of an input matrix 2 comprising a plurality of radar data values. In one embodiment, the dimensions of the input matrix 2 may be E×A×D, where

E is the number of elevation points, A is the number of azimuth points and D is the number of distance points in the input matrix 2. V and RCS may be the channels of the input matrix 2, where V is the number of velocity points and RCS is the radar cross section.

The system 100 also includes a bus 12. The bus 12 is coupled to the output of the convolutional network 4, for providing the output of the convolutional network 4 (processed radar data in which extracted features have been identified by the convolutional network) to other parts of the system 100.

The system 100 further includes a deconvolutional network 6. The deconvolutional network 6 includes an input, which is connected to the bus 12 for receiving the output of the convolutional network 4. The deconvolutional network 6 also includes a plurality of hidden layers. The hidden layers include deconvolution layers for classifying the features extracted from the radar data 2 by the convolutional network 4. The deconvolutional network 6 also includes a classification output, from which processed radar data in which the extracted features identified by the convolutional network 4 are classified.

The system 100 also includes a filter 10. The filter 10 has an input, which is coupled to the classification output of the deconvolutional network 6. The filter may comprise a filter layer located after a final one of the deconvolution layers in the sequence of deconvolution layers in the deconvolutional network 6.

The system 100 further includes a fully connected network 8. The fully connected network 8 has an input which is coupled to the bus 12 for receiving the output of the convolutional network 4. The fully connected network 8 also includes a plurality of fully connected layers. The fully connected layers are operable to determine a clutter threshold value from the output of the convolutional network 6. The fully connected network 8 further includes an output, which is connected to the filter 10 (e.g. by connection 130) to provide the clutter threshold value to the filter 10.

The neural network architecture of the system 100 of FIG. 1 may use various activation functions of the kind that are known in the art of neural networks. For instance, the activation function may be a linear activation function, a step activation function, a hyperbolic tangent activation function of a Rectified Linear (ReLu) activation function. The clutter threshold value may be calculated in accordance with the activation function.

The filter 10 is operable to use the clutter threshold value provided by the fully connected network 8 to filter noise and/or clutter from the classification output of the deconvolutional network 6. The filter 10 thereby produces a filtered classification output, which is then passed to the output 20 of the system.

The system 100 may also include a skip connections bus 11. The skip connections bus 11 includes one or more skip connections. The skip connections may be selectively coupleable between the convolutional network 4 and the deconvolutional network 6. In particular, and noting that the convolution layers of a convolutional network and the deconvolution layers of the deconvolutional network are typically provided in a linear sequence, the skip connections may be selectively coupleable between a convolution layer of the convolutional network 4 and a deconvolution layer of the deconvolutional network 6, so as to bypass any intervening convolution layers and deconvolution layers in the sequence. It is envisaged that the skip connections bus 11 may include skip connections for selectively coupling any convolution layer of the convolutional network 4 with any deconvolution layer of the deconvolutional network 6, to allow intervening layers to be bypassed in this way. Typically, however during one object classification operation, only one convolution layer would be connected to any one deconvolution layer.

The skip connections of the skip connections bus 11 can allow high-level extracted features that are learned during early convolution layers in the sequence of convolution layers of the convolutional network 4 to be passed directly to the deconvolutional network 6. Data can be fed from an early convolution layer of the convolutional network 4 (in addition to from the end of sequence of convolution layers outputted from the convolutional network 4), into a deconvolution layer of the deconvolutional network 6, thereby to retain high-level features (for instance the contours of an object) learned during early convolution layers of the convolutional network 4. This may significantly increase the speed and efficiency by which objects may be classified by the system 100.

The system 100 may further include a controller 30. The controller 30 may be operable control certain operational parameters of the system 100, including, for instance, a stride size, a padding size and a dropout ratio for the (layers in the) convolutional network 4, the deconvolutional network 6 and/or the fully connected network 8 of the neural network architecture. The controller 30 may also be operable to control the skip connections bus 11, for selectively coupling (and decoupling) the skip connections of the bus 11 between the between the convolution layers of the convolutional network 4 and the deconvolution layers of the deconvolutional network 6 as noted above.

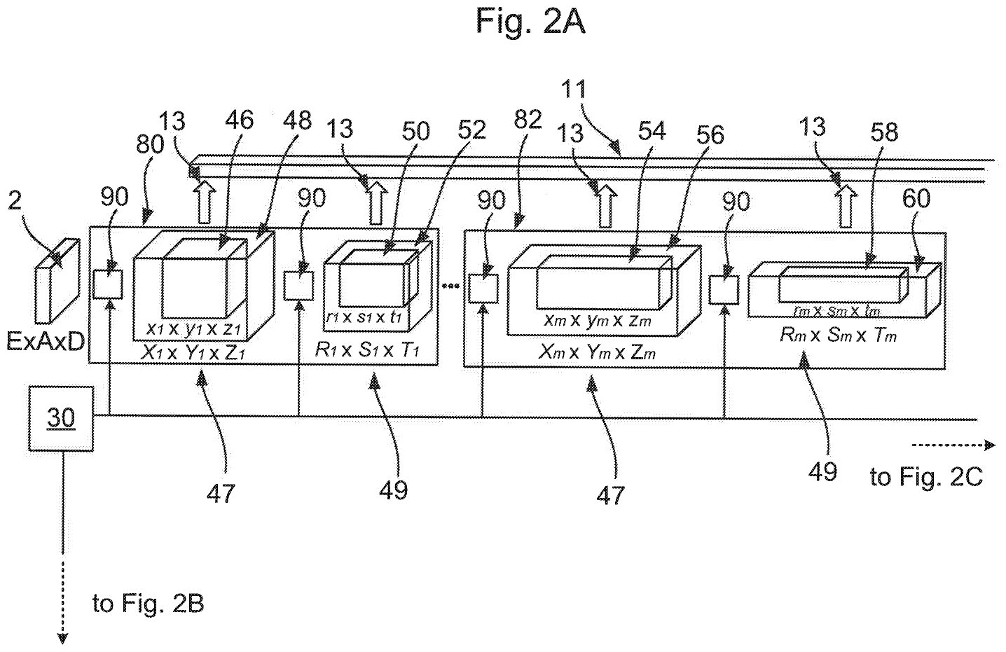

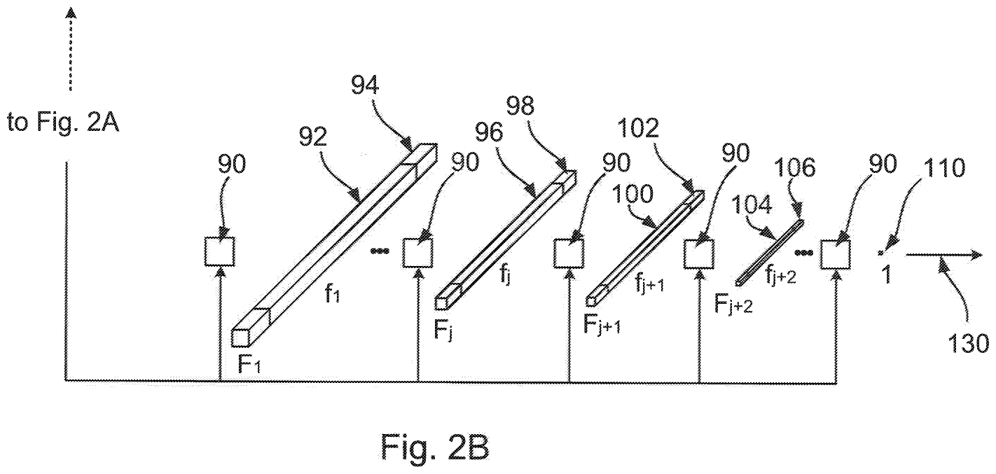

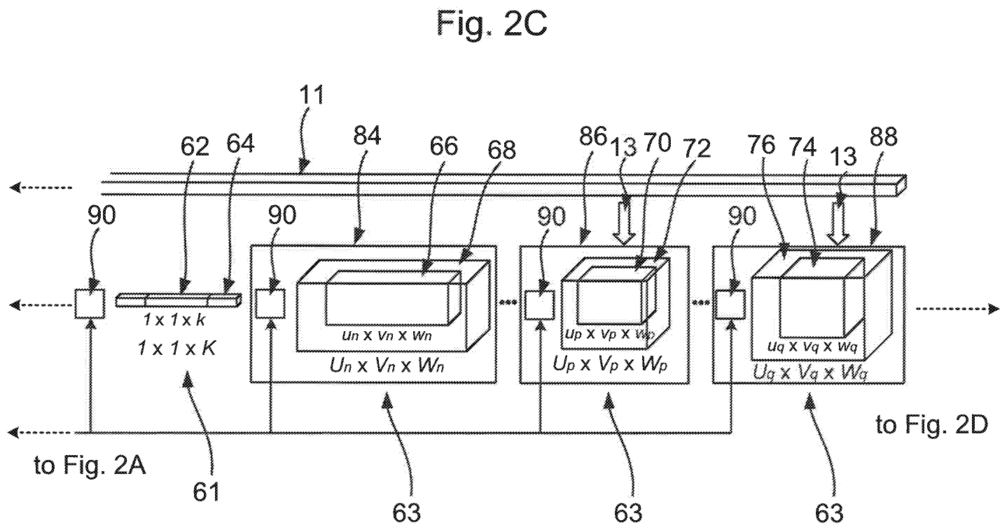

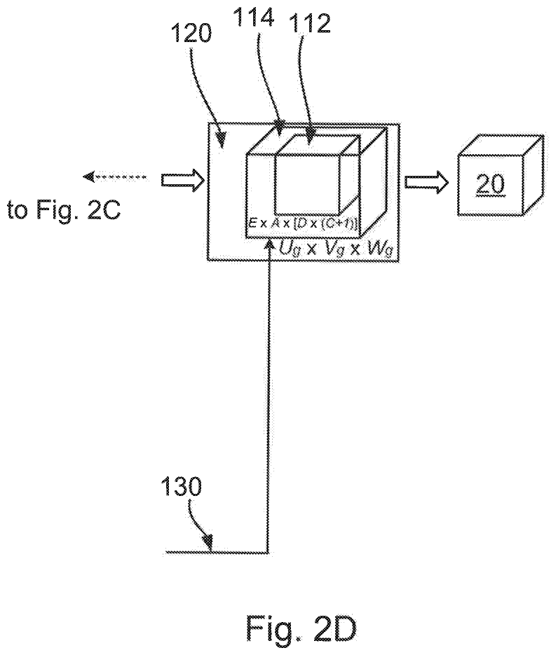

FIG. 2 shows the system 100 of FIG. 1 in more detail. In particular, FIG. 2A shows further details of the convolutional network 4, FIG. 2B shows further details of the fully connected network 8, FIG. 2C shows further details of the deconvolutional network 6 and FIG. 2D shows further details of the filter 10.

The convolutional network 4 (FIG. 2A) includes an input for receiving the radar data, which as noted above may be in the form of an input matrix 2. Again, in this embodiment, the input matrix has dimensions E×A×D.

The convolutional network 4 also includes a plurality of hidden layers 80, 82. The hidden layers 80, 82 may be arranged in a linear sequence. The convolutional network 4 may in principal include any number of hidden layers—for clarity only the first hidden layer 80 and the m^{th} hidden layer 82 are shown in FIG. 2A. The hidden layers 80, 82 each include a convolution layer 47. The convolution layers 47 of the hidden layers 80, 82 are operable to extract features from the radar data for subsequent classification by the deconvolutional network 6.

Each convolution layer 47 may comprise a perceptron cube 48, 56. The perceptron cubes 48, 56 shown in the figures outlines the envelope of available perceptrons that may be supported by the system 100. On the other hand, the cubes 46, 54 shown in the figures illustrate the perceptrons that may be employed by a given application, depending on the dimensions of the input matrix 2.

Each hidden layer 80, 82 may also include a subsampling layer 49. Each subsampling layer 49 may comprise a perceptron cube 52, 60. Again, the perceptron cubes 52, 60 shown in the figures outlines the envelope of available perceptrons that may be supported by the system 100. On the other hand, the cubes 50, 58 shown in the figures illustrate the perceptrons that may be employed by a given application, again depending on the dimensions of the input matrix 2.

The subsampling layer 49 in each hidden layer 80, 82 may be connected to the preceding convolution layer 47 by a layer connector fabric 90. Similarly, each convolution layer 47 in each hidden layer 80, 82 may be connected to the (e.g. subsampling layer 49 of the) preceding hidden layer by a layer connector fabric 90. Note that the layer connector fabric 90 of the first hidden layer 80 connects the first convolution layer 47 to the input of the convolutional network to receive the input matrix 2.

In the figures, x, y, z, s, t and w are all programmable parameters and can be supported up to maximum of X, Y, Z, R, S and T respectively. Note that X, Y and Z are used as symbols for dimensions of convolution layers 47 while R, S and T are used for dimensions of subsampling layers 49.

For the purposes of the present application, the term perceptron cube is not limited to a cubic arrangement of perceptrons, and it will be understood that the dimensions of each perceptron cube may not be equal to each other. Each perceptron cube may by implemented as one or more hardware layers.

The convolutional network 4 also includes an output located at the end of the sequence of hidden layers 80, 82. In the present embodiment the output may be considered to be the output of the m^{th} hidden layer (e.g. the output of the subsampling layer 49 of the hidden layer 82).

FIG. 2A also shows the skip connections bus 11. The arrows 13 schematically show the connections between the skip connections bus 11 and the various layers of the convolutional network 4.

FIG. 2A further shows the controller 30. The controller may be connected to each layer connector fabric 90 in the system 100 (see also the layer connector fabrics 90 in FIGS. 2B and 2C to be described below. This can allow the controller 30 to control parameters such as the stride size, padding size and dropout ratio for the (layers in the) convolutional network 4, the deconvolutional network 6 and/or the fully connected network 8 of the neural network architecture. Again, the controller 30 may also be operable to control the skip connections bus 11, for selectively coupling (and decoupling) the skip connections 13 of the bus 11.

Turning to FIG. 2C, the deconvolutional network 6 includes an input for receiving the output of the convolutional network 4. As described in relation to FIG. 1, the deconvolutional network 6 may be connected to the convolutional network 4 by a data bus 12. In this embodiment, the input of the deconvolutional network 6 may be formed by a layer connector fabric 90 as shown in FIG. 2C which receives the output of the convolutional network 4.

The layers of the deconvolutional network 6 up sample the output of the convolutional network 4 and classify the features extracted from the radar data by the convolutional network 4.

A first layer 61 of deconvolutional network 6 may be a 1×1 convolution layer with K filters. Note that in FIG. 2C, K denotes the number of filters supported by the system 100, whereas k denotes the number of filters actually used for a given application.

The deconvolutional network 6 also includes a plurality of hidden layers 84, 86, 88. The hidden layers 84, 86, 88 may be arranged in a linear sequence. The deconvolutional network 6 may in principal include any number of hidden layers—for clarity only the first hidden layer 84, a p^{th} hidden layer 86 and a (final) q^{th} hidden layer 88 are shown in FIG. 2C. The hidden layers 84, 86, 88 each include a deconvolution layer 63. As noted above, the deconvolution layers 63 of the hidden layers 84, 86, 88 are operable to classify the features extracted from the radar data by the convolutional network 4.

Each deconvolution layer 63 may comprise a perceptron cube 68, 72, 76. Again, the perceptron cubes 68, 72, 76 shown in the figures outline the envelope of available perceptrons that may be supported by the system 100. On the other hand, the cubes 66, 70, 74 shown in the figures illustrate the perceptrons that may be employed by a given application.

Each deconvolution layer 63 in each hidden layer 84, 86, 88 may be connected to the (e.g. deconvolution layer 63 of the) preceding hidden layer by a layer connector fabric 90.

Note that the layer connector fabric 90 of the first hidden layer 84 connects the first deconvolution layer 63 to the first layer 61.

In the figures, u, v, w are all programmable parameters of the deconvolution layers 63 and can be supported up to maximum of U, V and W, respectively.

The deconvolution layer 63 of the first hidden layer 84 is operable to up sample the output of the 1×1 convolution layer (the first layer 61) of deconvolutional network 6. A plurality of hidden layer 84, 86 comprising deconvolution layers 63 may follow the first hidden layer 84. These following layers may be selectively connectable to the skip connections bus 11.

The (q^{th}) deconvolution layer 63 of the final hidden layer in the sequence of hidden layers in the deconvolutional network 6 may have the dimensions E×A×[D×(C+1)] where C is the number of distinct classes that may be determined by the system 100 for features in the radar data that are extracted by the convolutional network 4.

The deconvolutional network 6 also includes a classification output located at the end of the sequence of hidden layers 84, 86, 88. In the present embodiment the output may be considered to be the output of the deconvolution layer 63 of the final hidden layer 88. The classification output outputs the radar data including classification of the features extracted from the radar data by the convolutional network 4.

Again, FIG. 2C shows the skip connections bus 11, in which the arrows 13 schematically show the connections between the skip connections bus 11 and the various layers of the deconvolutional network 6. Note that in this embodiment, there is no skip connection between the skip connections bus 11 and the first hidden layer 84.

Turning to FIG. 2B, the fully connected network 8 has an input coupled to the bus 12 for receiving the output of the convolutional network 4. The fully connected network 8 has a plurality of fully connected layers (1, j, j+1, j+2 . . . ), which may be arranged in a linear sequence. In the present embodiment, the input may be received by a layer connector fabric 90 located before a first layer of the sequence. Each fully connected layer in the sequence may be coupled to a following/preceding fully connected layer by a layer connector fabric 90. For clarity, FIG. 2B shows a subset of the fully connected layers of the fully connected network 8 in this embodiment.

The fully connected layers of the fully connected network 8 may typically have a depth of 1. As before, in FIG. 2B, the cubes 94, 98, 102, 106 show the envelope (F) supported by the system for each layer, while the cubes 92, 96, 100, 104 show the parts (f) of the supported envelope that are actually used for a given application.

The fully connected network 8 also has an output, which is supplied to the filter 10 by a connection 130. The fully connected network 8 is operable to straighten features learned from the convolutional network 4 and supply a clutter threshold value 110 to output supplied to the filter 10. The clutter threshold value 110 may be a single value, and may comprise a radar cross section value. The clutter threshold value 110 may be denoted Th, and in this embodiment may be calculated in accordance with the Rectified Linear (ReLu) activation function (in particular, the clutter threshold value 110 may form the “zero point” of the ReLu function as shown schematically in FIG. 4).

Turning to FIG. 2D, the filter 10 may have a filter layer 120 comprising a cube of “biased” Rectified Linear Units (ReLU) with same dimensions E×A×[D×(C+1)] as output of deconvolutional network 6. As before, in FIG. 2D, the cube 114 shows the envelope of supported units (U), while the cube 112 shows the units that are actually used for a given application. Note that the cube of the filter 10 may typically have the same dimensions as the output of the deconvolutional network 6, so that the filter 10 can correctly receive and filter the output of the deconvolutional network 6.

As noted above, the filter 10 receives the clutter threshold value 110 via the connection 130. The filter 10 uses the clutter threshold value 110 to filter the output of the deconvolutional network 6. In this embodiment, where the ReLu function is used as the activation function, the filter 10 outputs zero for any (e.g. RCS) values in the output of the deconvolutional network 6 that fall below the clutter threshold value. On the other hand, the filter returns any value of the output of the deconvolutional network 6 that falls above the clutter threshold value. Collectively, these values, and the zero values (filtered out because the corresponding values in the output from the deconvolutional network 6 fell below the clutter threshold value) form a filtered classification output of the filter 10. The filter 10 is operable to pass this filtered classification output to the output 20 of the system.

The operation of the fully connected network 8 and the filter 10, to calculate the clutter threshold value 110 and applying it in a filtering step may help in a backpropagation stage of training the neural network, where it may improve in the classification of objects of interest against clutter.

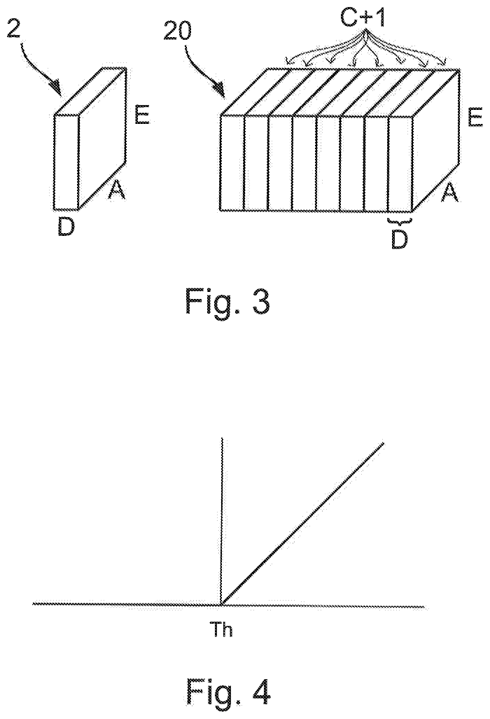

FIG. 3 compares the dimensions of the input matrix 2 and output 20 of the neural network architecture of FIG. 1 according to an embodiment of this disclosure. As mentioned previously, the input matrix 2 may have dimensions E×A×D. The output 20 may be made up of a matrix including C+1 sections, each section having the dimensions E×A×D, whereby the overall dimensions of the output matrix are E×A×[D×(C+1)]. Here, C is the number of distinct classes that may be determined by the system 100 for features in the radar data that are extracted by the convolutional network 4. Note that the “1” in the term “C+1” denotes an additional class, allocated to unclassified objects.

The layer connector fabrics 90 described herein may be considered to be an abstracted illustration of data-mapping through mathematical operation between two layers of the system 100.

For the convolutional network 4, each layer connector fabric 90 may, for instance:
connect elements of a convolution layer 47, as input to the operation, to the elements of a next sub-sampling layer 49 (of the same hidden layer 80, 82) as output of the operation, or
connect or elements of a sub-sampling layer 49, as input of the operation, to the convolutional layer 47 of subsequent hidden layer of convolutional network 4.

In case of a connection between a convolutional layer 47 and its successive sub-sampling layer 49, the layer connector fabric 90 may, for instance, apply a max-pooling, mean-pooling, min-pooling or a similar operation as is known in the art. The choice of operation that is used may be controlled by the controller 30.

In case of a connection between a sub-sampling layer 49 of a preceding hidden layer and convolution layer 47 of a following hidden layer, the layer connector fabric 90 may be a 2-dimensional convolution operation, dropout, flatten (for the last convolutional layer in the sequence), or another similar operation.

For deconvolution layers 63 in the deconvolutional network 6, the layer connector fabric 90 may be an up-sampling operation instead of a sub-sampling operation as in convolutional network 4.

A method of classifying objects using radar data may be performed as follows. This method may be implemented by, for example, the system of FIGS. 1 and 2.

The method may include obtaining radar data. The radar data may be obtained by a vehicle radar system of a vehicle. The radar data may be received (e.g. from the vehicle radar system) by a convolutional network. The convolutional network may be a convolutional network 4 of the kind described above in relation to FIGS. 1 and 2. As explained previously, the radar data may be provided to the convolutional network in the form of an input matrix, such as the input matrix 2.

The method may also include the convolutional network using a plurality of hidden layers comprising convolution layers to extract features from the radar data. These features may generally relate and correspond to the objects to be classified by the method.

The method may further include a deconvolutional network (e.g. the deconvolutional network 6 described above in relation to FIGS. 1 and 2) receiving an output of the convolutional network. The output of the convolutional network generally comprises processed radar data in which extracted features have been identified by the convolutional network. The deconvolutional network may be coupled to the convolutional network by a data bus (e.g. the bus 12).

The method may also include the deconvolutional network using a plurality of hidden layers comprising deconvolution layers to classify the features extracted from the radar data by the convolutional network. The method may further include the deconvolutional network providing a classification output, which may output processed radar data in which the extracted features identified by the convolutional network are classified.

The method may further include a fully connected network receiving the output of the convolutional network (e.g. via the bus 12), and then using a plurality of fully connected layers to determine a clutter threshold value from the output of the convolutional network.

The method may also include a filter using the clutter threshold value to filter noise and/or clutter from the classification output of the deconvolutional network to produce a filtered classification output.

In some embodiments, the method may include selectively coupling a skip connection between the convolutional network and the deconvolutional network for bypassing at least some of the convolution layers and deconvolution layers, as has been explained previously.

The system of FIG. 1 may be incorporated into, for example, a hardware accelerator or a graphics processing unit. The hardware accelerator or graphics processing unit may be provided in a vehicle, for instance as part of a vehicle radar system of the vehicle. The vehicle may, for instance, be a road vehicle such as a car, truck, lorry, van or bike.

Accordingly, there has been described a system and method to classify objects using radar data obtained by an automotive radar. The system includes a convolutional network having a plurality of hidden layers comprising convolution layers for extracting features from the radar data, and an output. The system also includes a deconvolutional network having a plurality of hidden layers comprising deconvolution layers for classifying the features extracted from the radar data, and a classification output. The system also includes a filter having an input coupled to the classification output of the deconvolutional network. The system further includes a fully connected network having a plurality of fully connected layers for determining a clutter threshold value from the output of the convolutional network. The filter is operable to use the clutter threshold value to filter noise and/or clutter from the classification output of the deconvolutional network and pass a filtered classification output to an output of the system.

Although particular embodiments of this disclosure have been described, it will be appreciated that many modifications/additions and/or substitutions may be made within the scope of the claims.

1. A system operable to classify objects using radar data obtained by an automotive radar, the system comprising:
a convolutional network comprising:
an input for receiving the radar data;
a plurality of hidden layers comprising convolution layers for extracting features from the radar data;
and an output;
a bus coupled to the output of the convolutional network;
a deconvolutional network comprising:
an input coupled to the bus to receive the output of the convolutional network,
a plurality of hidden layers comprising deconvolution layers for classifying the features extracted from the radar data by the convolutional network; and
a classification output;
a filter having an input coupled to the classification output of the deconvolutional network;
a fully connected network comprising:
an input coupled to the bus for receiving the output of the convolutional network;
a plurality of fully connected layers for determining a clutter threshold value from the output of the convolutional network; and
an output connected to the filter to provide the clutter threshold value to the filter; and
an output coupled to the filter,
wherein the filter is operable to use the clutter threshold value to filter noise and/or clutter from the classification output of the deconvolutional network and pass a filtered classification output to the output of the system.

2. The system of claim 1 further comprising a skip connections bus having one or more skip connections couplable between the convolutional network and the deconvolutional network for bypassing at least some of the convolution layers and deconvolution layers.

3. The system of claim 2, wherein each skip connection allows high-level extracted features learned during early convolution layers of the convolutional network to be passed directly to the deconvolutional network.

4. The system of claim 2 or claim 3, operable selectively to couple/decouple a said skip connection between a said convolution layer and a said deconvolution layer.

5. The system of claim 1, wherein the filter is operable to filter out any detected features having a value less than the clutter threshold value.

6. The system of claim 5, wherein the value of each detected feature comprises a radar cross section value.

7. The system of claim 1, wherein the clutter threshold value is a single value.

8. The system of claim 1 comprising a controller for controlling at least one of:
a stride size;
a padding size; and
a dropout ratio,
for each layer in the convolutional and/or deconvolutional network.

9. The system of claim 1, wherein the radar data comprises at least one of range, doppler and spatial information.

10. The system of claim 1, wherein the filtered classification output classifies objects detected by the automotive radar.

11. A hardware accelerator comprising the system of claim 1.

12. A graphics processing unit comprising the system of claim 1.

13. A vehicle comprising the hardware accelerator of claim 11.

14. A method of classifying objects using radar data obtained by an automotive radar, the method comprising:
a convolutional network:
receiving the radar data; and
using a plurality of hidden layers comprising convolution layers to extract features from the radar data;
a deconvolutional network: <receiving an output of the convolutional network;
using a plurality of hidden layers comprising deconvolution layers to classify the features extracted from the radar data by the convolutional network; and
providing a classification output;
a fully connected network:
receiving the output of the convolutional network; and
using a plurality of fully connected layers to determine a clutter threshold value from the output of the convolutional network; and
a filter using the clutter threshold value to filter noise and/or clutter from the classification output of the deconvolutional network to produce a filtered classification output.

15. The method of claim 14 comprising selectively coupling a skip connection between the convolutional network and the deconvolutional network for bypassing at least some of the convolution layers and deconvolution layers.

16. The method of claim 15, wherein each skip connection allows high-level extracted features learned during early convolution layers of the convolutional network to be passed directly to the deconvolutional network.

17. The method of claim 15, operable selectively to couple/decouple the skip connection between the convolution layer and the deconvolution layer.

18. The method of claim 14, wherein the filter is operable to filter out any detected features having a value less than the clutter threshold value.

19. The method of claim 18, wherein the value of each detected feature comprises a radar cross section value.

20. The method of claim 14, wherein the clutter threshold value is a single value.
